(19) United States
(12) Patent Application Publication
(10) Pub. No.: US 2015/0034180 A1
(43) Pub. Date: Feb. 5, 2015

(54) TANK PRESSURE CONTROL SOLENOID WITH PASSIVE TANK VACUUM RELIEF

(71) Applicant: Continental Automotive Systems, Inc., Auburn Hills, MI (US)

(72) Inventors: David W Balsdon, Chatham (CA); Brian Woods, Chatham (CA)

(21) Appl. No.: 14/333,989

(22) Filed: Jul. 17, 2014

Related U.S. Application Data
(60) Provisional application No. 61/861,576, filed on Aug. 2, 2013.

(51) Int. Cl. F16K 24/00

(52) U.S. Cl. CPC F16K 24/00
USPC 137/493

(57) ABSTRACT

A tank pressure control valve which provides for both controlled and passive vacuum relief functions with an additional component in a tank purge valve. The tank pressure control valve includes a second valve in addition to a purge valve to create a small sealing area on one side that opens easily against the tank pressure with the normal magnetic forces in a purge valve. The second valve is a sealing disk, which has an aperture to allow for the flow of purge vapor. One side of the disk has sealing on a larger area so the small vacuum forces open the valve against the spring force biasing the valve to a closed position. The design of the second valve uses a disk to provide precise flow control and passive vacuum relief.

### CROSS-REFERENCE TO RELATED APPLICATIONS

This application claims the benefit of U.S. Provisional Application No. 61/861,576 filed Aug. 2, 2013. The disclosure of the above application is incorporated herein by reference.

### FIELD OF THE INVENTION

The invention relates generally to a valve assembly which performs the functions of removing purge vapor from a fuel tank under pressure, and allowing passive vacuum relief of the fuel tank as necessary.

### BACKGROUND OF THE INVENTION

The amount of air pressure in a fuel tank varies with changes in temperature, and changes in the amount of fuel in the tank, such as during refueling and fuel consumption. In hot climates, the level of air pressure and amount of purge vapor in the tank is controlled by opening and closing a valve for very short pulses. This contains the vapors in the tank as much as possible, without exceeding a limit pressure for the tank. However, there are conditions where the tank also needs passive (not controlled) relief of vacuum pressure. Vacuum pressure in the fuel tank may occur during periods of fuel consumption during vehicle operation, and needs to be relieved to avoid reaching an undesirable level. However, typical valve assemblies are designed to only provide flow control, and have a separate valve used to provide vacuum relief.

Accordingly, there exists a need for a valve assembly which is able to provide flow control during a purge process, and vacuum relief.

### SUMMARY OF THE INVENTION

The present invention provides for both controlled flow of purge vapor and passive vacuum relief functions with an additional component in a tank purge valve. The invention adds a sealing disk to a purge valve to create a small sealing area on one side that opens easily against the tank pressure with the normal magnetic forces in a purge valve. The sealing disk has an aperture in the middle to allow for the flow of purge vapor. The second side of the disk has sealing on a larger area so the small vacuum forces open the valve against the spring force which biases the valve to a closed position. The design of the present invention uses a disk to provide precise flow control and vacuum relief.

In one embodiment, the invention is a tank pressure control valve assembly, which includes an overmold assembly having a first port, where the first port is in fluid communication with a fuel tank. A cap is connected to the overmold assembly, and a cap aperture is formed as part of the cap, such that the cap aperture forms part of a second port, and the cap aperture provides fluid communication between the overmold assembly cavity and the second port. The second port is in fluid communication with a carbon canister. An overmold assembly cavity having an inside surface is formed as part of the overmold assembly, and the first port is in fluid communication with the overmold assembly cavity. A solenoid assembly is disposed inside the overmold assembly adjacent the overmold assembly cavity, and the solenoid assembly controls the movement of an armature. A stopper portion is connected to the armature, and the valve assembly also includes a secondary valve member, where the stopper portion is selectively in contact with the secondary valve member.

During a first mode of operation, the solenoid assembly is used to move the armature and stopper portion away from the secondary valve member, and control the flow of purge vapor flowing from the fuel tank into the first port, through the overmold assembly cavity, and out of the second port. During a second mode of operation, the overmold assembly cavity is exposed to vacuum pressure in the fuel tank, and the vacuum pressure moves the secondary valve member, the stopper portion, and the armature away from the inside surface, allowing air to pass from the second port, through the cap aperture and into the overmold assembly cavity, through the first port, and into the fuel tank, relieving vacuum pressure in the fuel tank.

The secondary valve member has several components. In one embodiment, the secondary valve member includes a core portion selectively in contact with the stopper portion and the inside surface. The core portion includes a base, and a flow aperture is integrally formed as part of the base. A flange member is also integrally formed as part of the base, and is part of the core portion. An outer seal member substantially surrounds the flange member, and a lip is formed as part of the outer seal member, such that the lip is selectively in contact with the inside surface. During the first mode of operation, the stopper portion is selectively moved away from the core portion to control the amount of purge vapor flow through the flow aperture. During the second mode of operation, the vacuum pressure in the overmold assembly cavity moves the secondary valve member, the stopper portion, and the armature such that the lip moves away from the inside surface.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of part of an air flow system for a vehicle, having a tank pressure control valve assembly, according to embodiments of the present invention;

FIG. 2 is a sectional view of a tank pressure control valve assembly, according to embodiments of the present invention; and

FIG. 3 is an enlarged view of the circled portion of FIG. 2.

### DETAILED DESCRIPTION OF THE PREFERRED EMBODIMENTS

The following description of the preferred embodiment(s) is merely exemplary in nature and is in no way intended to limit the invention, its application, or uses.

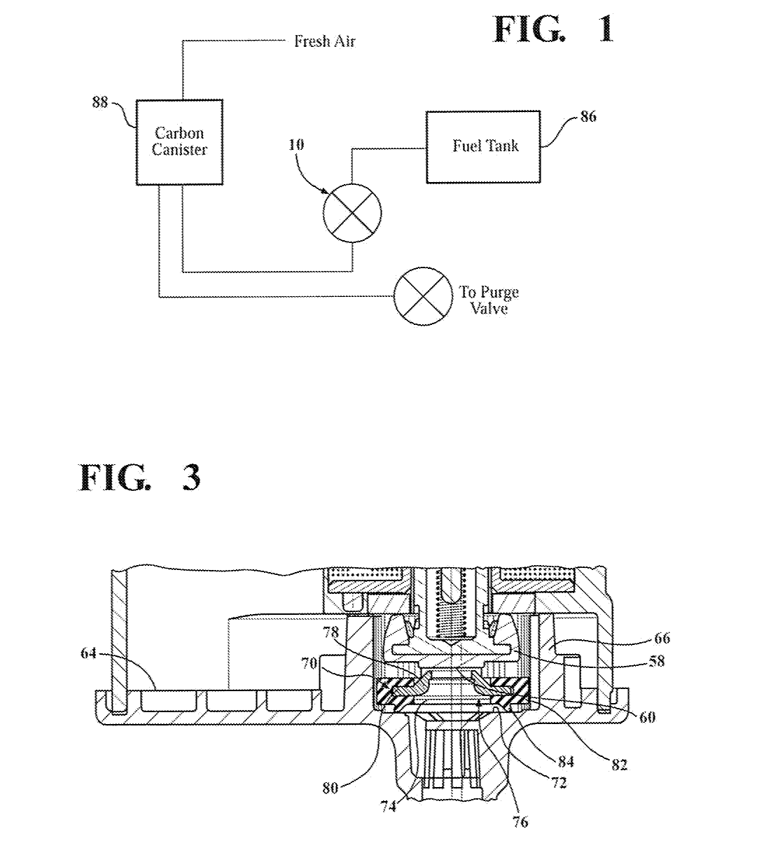

A tank pressure control (TPC) valve having a multi-function valve assembly is shown in FIGS. 1-3 generally at 10. The TPC valve 10 includes an inlet port 12 in fluid communication with a fuel tank 86. The TPC valve 10 includes a housing, which in this embodiment is an overmold assembly 14, and disposed within the overmold assembly 14 is an actuator in the form of a solenoid assembly, shown generally at 16, and the solenoid assembly 16 is disposed within a cavity, shown generally at 18, formed as part of the overmold assembly 14. The cavity 18 includes an inner wall portion 20, and also forming part of the cavity 18 is an outer wall portion 22 of the overmold assembly 14.

The solenoid assembly 16 includes a stator insert 24 which surrounds a support 26 formed as part of the overmold assembly 14. A first washer 28 is disposed between an upper wall 30 of the overmold assembly 14 and a bobbin 32. The bobbin 32 is surrounded by a coil 34, and two straps (not shown) surround the coil 34. There is a sleeve 36 which is surrounded by the bobbin 32, and the sleeve 36 partially surrounds a moveable armature 38. The armature 38 includes a cavity, shown generally at 40, and located in the cavity 40 is a spring 42, which is in contact with an inner surface 48 of the cavity 40. The spring 42 is also mounted on a narrow diameter portion 44 of the support 26, and the spring 42 biases the armature 38 away from the stator insert 24. Disposed between part of the armature 38 and the bobbin 32 is a second washer 46. Connected to the overmold assembly 14 is a cap 50, and formed as part of the cap 50 is a cap aperture 54 and a second port 68. The cap aperture 54 is partially formed as part of the second port 68, and the second port 68 is connected to and in fluid communication with a carbon canister 88. Purge vapor is able to flow from an overmold assembly cavity, shown generally at 56, formed as part of the overmold assembly 14, through the cap aperture 54, and out of the second port 68.

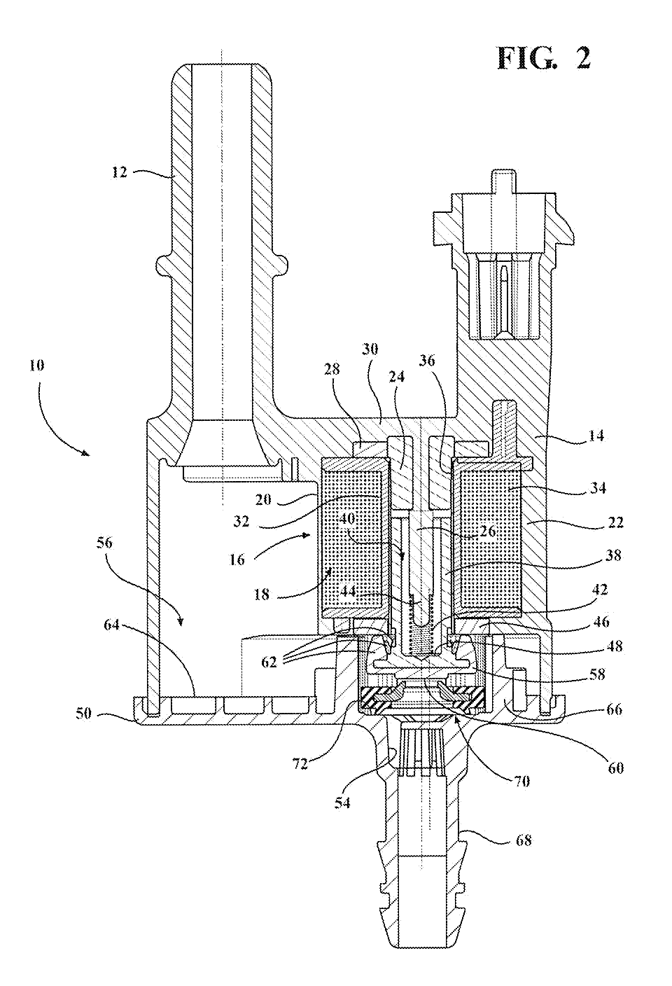

The armature 38 includes a first valve member, which in this embodiment is a stopper portion 58 made of a rubber or other flexible material. The stopper portion 58 includes a contact surface 60 which contacts a second or secondary valve member, shown generally at 70, when the armature 38 is in the closed position. The stopper portion 58 includes a plurality of post members 62, which are of the same durometer, but are of different sizes, and therefore have different levels of stiffness. The largest post members 62 are in contact with the bottom surface of the washer 46 when the armature 38 is in the closed position, as shown in FIG. 2. The smaller post members 62 contact the bottom surface of the washer 46 when the armature 38 moves to the open position. The spring 42 biases the armature 38 and the stopper portion 58 away from the stator insert 24 and toward the second valve member 70, and therefore biases the armature 38 and stopper portion 58 towards the closed position. The coil 34 is energized to move the armature 38 away from the second valve member 70, placing the solenoid assembly 16 in an open position. The more the coil 34 is energized, the further the armature 38 moves away from the second valve member 70, and the greater number of post members 62 contact the bottom surface of the washer 46. The movement of the armature 38 to open and close the solenoid assembly 16 controls the amount of purge vapor allowed to pass through the TPC valve 10, and into the canister 88.

Because the post members 62 are made of rubber, the post members 62 are able to deform as the armature 38 is moved further away from the second valve member 70. The largest post members 62 in contact with the bottom surface of the washer 46 deform first when the armature 38 moves away from the second valve member 70. As the armature 38 moves further away from the second valve member 70, more of the post members 62 contact the bottom surface of the washer 46, and then begin to deform as the armature 38 moves even further away from the second valve member 70. The deformation of the post members 62 (when the armature 38 is moved to the open position away from the second valve member 70) functions to dampen the movement of the armature 38, eliminating noise, and preventing metal-to-metal contact between the armature 38 and the stator insert 24.

Disposed between the bottom surface of the washer 46 and an inside surface 64 of the cap 50 is a filter 66. The filter 66 is made of several blades of plastic which are adjacent to one another. The filter 66 is designed to limit the size of debris and particles passing through the blades of plastic to less than 0.7 millimeters. The distance between the armature 38 and the stator insert 24 is about 1.0 millimeters, and is the maximum allowable distance between the contact surface 60 of the stopper portion 58 and the second valve member 70. The filter 66 ensures that no particles may pass through the filter 66 that are too large to affect the functionality of the solenoid assembly 16 (the particles being too large to fit between the second valve member 70 and the stopper portion 58) when the armature 38 is in the open position.

The second valve member 70 is disposed between the stopper portion 58 and an area 72 of the inside surface 64 surrounded by the filter 66. The second valve member 70 includes a flow aperture 74 formed as part of a core portion 76, where the contact surface 60 is in contact with the core portion 76 when the armature 38 is in the closed position. The core portion 76 includes a base 78 and a flange member 80, and surrounding part of the base 78 and the flange member 80 is a outer seal member 82. The seal member 82 includes a lip 84 selectively in contact with the area 72 of the inside surface 64 surrounded by the filter 66.

As mentioned above, the more the coil 34 is energized, the further the armature 38 and the stopper portion 58 move away from the second valve member 70, placing the solenoid assembly 16 in an open position, allowing purge vapor to pass from the overmold assembly cavity 56, through the flow aperture 74, the cap aperture 54 and out of the second port 68. The purge vapor is then able to flow into the carbon canister 88.

The valve 10 provides a flow path between the fuel tank 86 and the carbon canister 88, where the flow path includes the inlet port 12, the overmold assembly cavity 56, the stopper portion 58, the cap aperture 54, and the second port 68, and during process when purge vapor is removed from the fuel tank 86, the flow aperture 74 is part of the flow path as well. The purge vapor flows through the flow path in one direction, and air for vacuum pressure relief flows in another direction. Both the stopper portion 58 and the secondary valve member 70 are disposed in this same flow path.

During operation, if there is a need to allow purge vapor to move from the fuel tank 86 to the carbon canister 88, such as during times of refueling or an increase in pressure in the fuel tank 86 due to an increase in temperature, the coil 34 is energized enough to overcome the biasing force of the spring 42 to move the armature 38 and the stopper portion 58 away from the second valve member 70, allowing vapor in the fuel tank 86 to flow in a first direction and flow from the inlet port 12, through the overmold assembly cavity 56, through the flow aperture 74 of the second valve member 70, through the flow aperture 74, and out of the second port 68, and into the carbon canister 88.

If the vehicle is operating under conditions such that there is a vacuum condition in the fuel tank 86, such as during typical driving when the level of fuel in the tank 86 is reduced as the fuel is consumed, or because of a decrease in temperature when the vehicle is parked, air is allowed to pass from the canister 88 through the valve 10 and into the fuel tank 86 to relieve the vacuum pressure in the fuel tank 86. More specifically, once the vacuum pressure in the fuel tank 86 reaches a predetermined level, air is drawn from the canister 88 through the valve 10. The vacuum pressure applies force to the second valve member 70 such that once enough force is applied to the second valve member 70 to overcome the biasing force of the spring 42, the armature 38, the stopper portion 58, and second valve member 70 move away from the inside surface 64, such that the lip 84 is no longer in contact with the inside surface 64, allowing air from the canister 88 to flow from the canister 88 into the second port 68, the cap aperture 54 and into the overmold assembly cavity 56; the air then flows through the first port 12 into the fuel tank 86. The air is drawn past the second valve member 70, and more specifically the lip 84, because the lip 84 is moved away from the inside surface 64. The flow of air from the canister 88 to the fuel tank 86 provides a vacuum pressure relief function, preventing the vacuum pressure in the fuel tank 86 from reaching undesirable levels.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
an valve assembly, including:
a housing;
an actuator disposed within the housing;
a cavity formed as part of the housing, the cavity adjacent the actuator;
a first valve member, the movement of the first valve member controlled by the actuator;
a second valve member selectively in contact with the first valve member; and
wherein during a first mode of operation, the actuator controls the movement of the first valve member between an open position and a closed position to allow purge vapor to flow from the cavity through the second valve member and out of the housing, and in a second mode of operation, when vacuum pressure in the cavity reaches a predetermined level, the vacuum pressure in the cavity moves the first valve member and the second valve member such that air flows into the housing and into the cavity, relieving the vacuum pressure in the cavity.

2. The apparatus of claim 1, the housing further comprising an overmold assembly.

3. The apparatus of claim 1, the cavity further comprising an overmold assembly cavity.

4. The apparatus of claim 1, further comprising:
a first port formed as part of the housing, the first port in fluid communication with the cavity and a fuel tank; and
a second port selectively in fluid communication with the cavity and a carbon canister;
wherein during the first mode of operation, the actuator is used to move the first valve member away from the second valve member, and control the flow of purge vapor flowing from the first port, through the cavity, and out of the second port, and in the second mode of operation, vacuum pressure in the cavity moves the first valve member and the second valve member, allowing air to pass from carbon canister into the second port and into the overmold assembly cavity, through the first port, and into the fuel tank, relieving vacuum pressure in the fuel tank.

5. The apparatus of claim 4, further comprising:
a cap connected to the housing; and
a cap aperture formed as part of the cap such that the cap aperture forms at least part of the second port;
wherein during the first mode of operation, the purge vapor flows from the first port, the cavity, through the cap aperture, and out of the second port when the first valve member is in the open position, and during the second mode of operation, and the vacuum pressure reaches a predetermined level to move the first valve member and the second valve member, the air flows from the second port, through the cap aperture, into the cavity, and out of the first port.

6. The apparatus of claim 1, the actuator further comprising a solenoid assembly.

7. The apparatus of claim 1, further comprising an armature controlled by the actuator, the first valve member connected to the armature.

8. The apparatus of claim 7, the first valve member further comprising a stopper portion connected to the armature, wherein the stopper portion is selectively in contact with the second valve member as the actuator moves the armature and the stopper portion between the open position and the closed position.

9. The apparatus of claim 1, the second valve member further comprising:
a core portion selectively in contact with the first valve member;
a flow aperture formed as part of the core portion; and
an outer seal member connected to the core portion;
wherein during the first mode of operation, the first valve member is selectively moved away from the core portion to control the amount of purge vapor flow through the flow aperture, and during the second mode of operation, the vacuum pressure in the cavity moves the first valve member, the core portion, and the outer seal such that air is allowed to flow into the cavity of the housing.

10. The apparatus of claim 9, the second valve member further comprising:
a base formed as part of the core portion, the flow aperture formed as part of the base;
a flange member integrally formed with the base, the flange member being part of the core portion; and
a lip formed as part of the outer seal member;
wherein during the second mode of operation, the lip is selectively in contact with an inside surface of the cavity such that when the vacuum pressure in the cavity reaches a predetermined value, the lip moves away from the inside surface.

11. The apparatus of claim 1, wherein the first valve member and the second valve member are in the same flow path.

12. A valve assembly, comprising:
an overmold assembly;
an overmold assembly cavity formed as part of the overmold assembly such that the overmold assembly cavity is in fluid communication with a fuel tank and a carbon canister;
an inside surface being part of the overmold assembly cavity;
an actuator disposed in the overmold assembly adjacent the overmold assembly cavity;
a first valve member connected to the actuator such that the movement of the first valve member is controlled by the actuator; and
a second valve member selectively in contact with the first valve member and the inside surface;
wherein during a first mode of operation, the actuator moves the first valve member relative to the second valve member to control the flow of purge vapor flowing from the fuel tank, through the overmold assembly cavity, and into the carbon canister, and in a second mode of operation, the overmold assembly cavity is exposed to vacuum pressure in the fuel tank such that the vacuum pressure moves the second valve member and the first valve member away from the inside surface, allowing air to pass from the carbon canister into the overmold assembly cavity, and into the fuel tank, relieving vacuum pressure in the fuel tank.

13. The valve assembly of claim 12, further comprising:
an armature, the armature being part of the actuator; and
a stopper portion connected to the armature, the stopper portion being at least part of the first valve member;
wherein during the first mode of operation, the stopper portion selectively contacts the second valve member as the purge vapor flows from the overmold assembly cavity, out of the overmold assembly and into the carbon canister.

14. The valve assembly of claim 12, further comprising:
a cap connected to the overmold assembly; and
a cap aperture formed as part of the cap;
wherein the purge vapor flows from the overmold assembly cavity through the cap aperture during the first mode of operation, and the air flows through the cap aperture into the overmold assembly cavity during the second mode of operation.

15. The valve assembly of claim 14, further comprising:
a first port formed as part of the overmold assembly, the first port in fluid communication with the fuel tank; and
a second port formed as part of the cap such that at least a portion of the cap aperture extends into the second port, the second port in fluid communication with the carbon canister;
wherein during the first mode of operation and the first valve member is in the open position, purge vapor flows from the first port into the overmold assembly cavity, through the cap aperture and through the second port, and during the second mode of operation and the second valve member is moved away from the inside surface, air flows from the carbon canister, through the second port, through the cap aperture and into the overmold assembly cavity, through the first port, and into the fuel tank.

16. The valve assembly of claim 12, the second valve member further comprising:
a core portion selectively in contact with the first valve member;
a flow aperture formed as part of the core portion;
an outer seal member connected to the core portion; and
a lip formed as part of the outer seal member;
wherein during the first mode of operation, the first valve member is selectively moved away from the core portion to control the amount of purge vapor flow through the flow aperture, and during the second mode of operation, the vacuum pressure in the overmold assembly cavity moves the first valve member, the core portion, and the outer seal such that the lip is moved away from the inside surface, and air flows into the housing and into the overmold assembly cavity.

17. The valve assembly of claim 16, the second valve member further comprising:
a base formed as part of the core portion, the flow aperture formed as part of the base; and
a flange member integrally formed with the base, the flange member being part of the core portion;
wherein the outer seal partially surrounds the base and the flange member.

18. The valve assembly of claim 12, the actuator further comprising a solenoid assembly.

19. A tank pressure control valve assembly, comprising:
an overmold assembly;
a first port formed as part of the overmold assembly, the first port in fluid communication with a fuel tank;
a cap connected to the overmold assembly;
a second port formed as part of the cap, the second port in fluid communication with a carbon canister;
an overmold assembly cavity formed as part of the overmold assembly, the first port in fluid communication with the overmold assembly cavity;
an inside surface formed as part of the cap, the inside surface forming a part of the overmold assembly cavity;
a solenoid assembly disposed inside the overmold assembly adjacent the overmold assembly cavity;
an armature disposed in the overmold assembly, the movement of the armature controlled by the solenoid assembly;
a stopper portion connected to the armature;
a cap aperture formed as part of the cap, the cap aperture formed as part of the second port, such that the cap aperture provides fluid communication between the overmold assembly cavity and the second port; and
a secondary valve member, the stopper portion selectively in contact with the secondary valve member;
wherein during a first mode of operation, the solenoid assembly is used to move the armature and stopper portion away from the secondary valve member, and control the flow of purge vapor flowing from the first port, through the overmold assembly cavity and the secondary valve member, and out of the second port, and in a second mode of operation, vacuum pressure in the overmold assembly cavity moves the secondary valve member, the stopper portion, and the armature away from the inside surface, allowing air to pass from the second port, through the cap aperture and into the overmold assembly cavity, through the first port, and into the fuel tank, relieving vacuum pressure in the fuel tank.

20. The tank pressure control valve assembly of claim 19, the secondary valve member further comprising:
a core portion selectively in contact with the stopper portion and the inside surface;
a flow aperture formed as part of the core portion;
a base formed as part of the core portion, the flow aperture formed as part of the base;
a flange member integrally formed as part of the base, the flange member being part of the core portion;
a outer seal member substantially surrounding the flange member; and
a lip formed as part of the outer seal member, the lip selectively in contact with the inside surface;
wherein during the first mode of operation, the stopper portion is selectively moved away from the core portion to control the flow of purge vapor through the flow aperture, and during the second mode of operation, the vacuum pressure in the overmold assembly cavity moves the secondary valve member, the stopper portion, and the armature such that the lip moves away from the inside surface.
